(19) United States
(12) Patent Application Publication
(10) Pub. No.: US 2004/0051383 A1
(43) Pub. Date: Mar. 18, 2004

(54) Switching mode current limiting power controller circuit

(76) Inventors: Charles Albert Clark JR., Chatsworth, CA (US); Brian Allen Noel Koch, Woodland Hills, CA (US)

Correspondence Address: Jeffrey J. Chapp, Artz & Artz, P.C., Suite 250, 28333 Telegraph Road, Southfield, MI, 48034, US

(21) Appl. No.: 10/242,157

(22) Filed: Sep. 12, 2002

(51) Int. Cl. H02J 3/00; H02J 1/00

(52) U.S. Cl. 307/36

(57) ABSTRACT

A remote power controller circuit (58) including a main switch (98) and a current limiting circuit (82). The main switch (82) has a switching duty factor and is operative between a first state and a second state. The main switch (98) when in the first state allows current (60) to pass to an output terminal (92) and when in the second state preventing current (60) from passing to the output terminal (92). The current limiting circuit (82) is electrically coupled to the main switch (98) and includes a limiting inductor (134) that controls rate of change of current flow to the output terminal (92). A flyback diode (130) is electrically coupled to the limiting inductor (134) and provides a current path for the limiting inductor (134) to discharge when the main switch (98) is in the second state. A method of limiting current flow through the remote power controller circuit (58) is also provided.

### TECHNICAL FIELD

The present invention relates generally to remote power controllers for direct current power distribution systems, and more particularly, to a method and apparatus for efficiently limiting current through a remote power controller channel.

### BACKGROUND OF THE INVENTION

Multi-channel remote power controller (RPC) assemblies are utilized in various direct current power distribution systems. The assemblies may include multiple RPCs corresponding to multiple load channels. The RPCs function as remote switches and circuit breakers activating and deactivating current from a single power source to various sets of loads.

The RPC channels may be modular and packaged together as a single unit having multiple channels paralleled to provide required power and protection levels for the various sets of loads. The single unit design allows the RPCs to be flexible and to be applied throughout a power system. The single unit design also allows for several RPC units having different total power capacities to be fabricated using similar building blocks.

Referring now to FIG. 1, a schematic view of a prior art RPC 10, is shown. The RPC 10 supplies power to a load. A main switch 12 receives power and an input signal, in the form of an “ON/OFF” command, through an input terminal 16. When the RPC 10 is in an “ON” state, as determined by state of input signal 14, through terminal 15, current 17 passes from the input terminal 16 through the main switch 12 to a current sensor 18. The current 17 is monitored by the current sensor 18 and passes to an output terminal 20 before being received by a load, not shown. The main switch 12 is operated by a feedback loop 22. The feedback loop 22 includes the current sensor 18, a current amplifier 24, and a driver 26.

The RPC 10 has a current limiting feature in that current 17 passing through the main switch 12 is measured via the current sensor 18, the output of which is then compared to a current reference signal 28. When the measured current level is less than a level of the current reference signal 28, the driver 26 fully drives the main switch 12, assuring minimal voltage drop across the switch. When the measured current level is greater than or equal to a current level of the current reference signal 28 the driver 26 reduces drive to the main switch 12, to control current through the switch 12 to a level nominally equal to the level set by the current reference signal 28, preventing damage to various componentry.

Output of the current amplifier 24 is thresholded by a threshold comparator 25 having a bi-valued output level, which is integrated by an integrator 30. Output of the integrator 30 is then compared to a reference time duration signal 32 by a trip comparator 34. When the measured current level is above a predetermined value and remains above that value for a length of time that is greater than a reference time duration signal 32 a fault exists. The trip comparator 34 upon determining that a fault exists signals the driver 26 to deactivate the main switch 12. A snubber circuit 36 is incorporated at the input terminal 16 to limit voltage transients when main switch 12 is opened under load. A freewheeling diode 38 is electrically coupled to the output terminal 20 to provide a recirculation path for the current flowing to external cable and loads, both of which having various inductance levels.

To prevent a fault on one load from pulling down or browning out the voltage level on other loads that are fed from the same power source, current limiting is desirable prior to tripping, referring to deactivation of a channel, and is commonly used in RPCs. Current limiting requires a feedback loop of finite bandwidth, which has a finite transport delay.

One disadvantage associated with existing RPC assemblies is that peak “let-through” current passing through a RPC can cause power quality degradation, dips and transients, on other channels that are operating from the same power source. Transport delay and bandwidth limitation of the feedback loop prevents instant activation of the current limiting feature. The resulting let-through current causes the dips and voltage transients on corresponding loads in turn causing the loads not to function or to malfunction. The only existing factor that limits this current let-through effect is the inductances of cables and other parasitic impedances that limit rate of rise of current during a hard fault until the current limiting loop overrides and assumes control.

Another disadvantage with existing RPC assemblies is resulting interactions between feedback loops. Paralleled RPCs that are supplying the same load are not only interconnected at the output terminals but also between current amplifiers and drivers, which is represented by break 40 in FIG. 1. Bandwidth of the current limiting loop is usually set as wide as practically possible to minimize let-through currents and the degradation of power quality they produce. Paralleling of two or more channels, each channel having an associated feedback loop, is likely to result in interactions between the loops due to shared impedances, including feeder and load cable inductances and load/fault impedances, that couple the loops. The interactions of the loops can result in high current ripple during current limiting, inaccurate current limiting levels, as well as inaccurate trip delay time.

Additionally, most current limiting loops put a RPC switch element into a “linear” mode while controlling current. Therefore, under certain fault conditions, such as a short circuit on a RPC output, the switch functions with a full source voltage across it while conducting at the current limit level. Resulting apparent power, which is equal to product of the full source voltage and the current limit level, is at a high level. This high power level cannot be sustained for any significant time, usually no longer than 30-100 ms, unless prohibitive amounts of cooling are provided, which are impractical. The stated occurrence is especially true in high voltage DC distribution systems operating with voltages greater than 100V.

Master-Slave topologies have been used to solve the interaction problems between current limiting loops associated with paralleled channels. Unfortunately, to use the topologies a prior knowledge of which channels are to be paralleled is required. Control interconnection requirements between the Master and Slave channels may also be required. Also using these topologies eliminates the ability to freely parallel channels.

Mechanical switches have been used in RPCs in DC distribution systems for many years, but are not practical without current limiting. The mechanical switches cannot avoid snubbing, absorbing transient energy as not to reach a high voltage level, and power quality degradation. Current limiting must be provided upstream from the mechanical switches, since the switches are slow to open and tend to weld closed when used to interrupt fault currents at bus voltages above 28V. Also, significant snubbing must be used to limit voltage transients when switch contacts open under load, even when there is no fault present. In order to perform current limiting upstream considerable circuitry complexity must be added to designs, which may still suffer from interactions of the current limit loops.

It would therefore be desirable to develop a technique for limiting current through a RPC channel without having current interaction problems, complicated snubbing circuitry, and power quality degradation.

### SUMMARY OF THE INVENTION

The present invention provides a method and apparatus for controlling level of current through a remote power controller channel. A remote power controller circuit is provided including a main switch and a current limiting circuit. The main switch has a switching duty factor and is operative between a first state and a second state. The main switch when in the first state allows current to pass to an output terminal and when in the second state preventing current from passing to the output terminal. The current limiting circuit is electrically coupled to the main switch and includes a limiting inductor that controls rate of change of current flow to the output terminal. A flyback diode is electrically coupled to the limiting inductor and provides a current path for the limiting inductor to discharge when the main switch is in the second state. A method of performing the same is also provided.

One of several advantages of the present invention is the ability to control the turn on rate and the turn off rate of the main switch during normal, non-fault operation, thereby providing soft powering and depowering of a load. Soft powering of a load minimizes interactions and ripple effects on other channels.

Another advantage of the present invention is the ability to also operate the main switch quickly to achieve duty factor controlled current limiting. The ability to control the switching duty factor of the main switch increases versatility and modularity, such that the present invention may be used for an increased number of applications and aids in the prevention of damage to related circuitry and loads.

Furthermore, the present invention provides averaged current limiting via the limiting inductor as well as the ability to achieve stable operation of paralleled channels while current limiting. The current limiting features of the present invention eliminate the need for interconnections between parallel channels except for at output terminals.

Moreover, the present invention by controlling the rate of change of current passing through the output terminal eliminates the need for snubbing when the remote power controller channel trips as a result of a load fault. Thereby, reducing manufacturing costs involved in production of a remote power controller.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a schematic view of a prior art remote power controller;

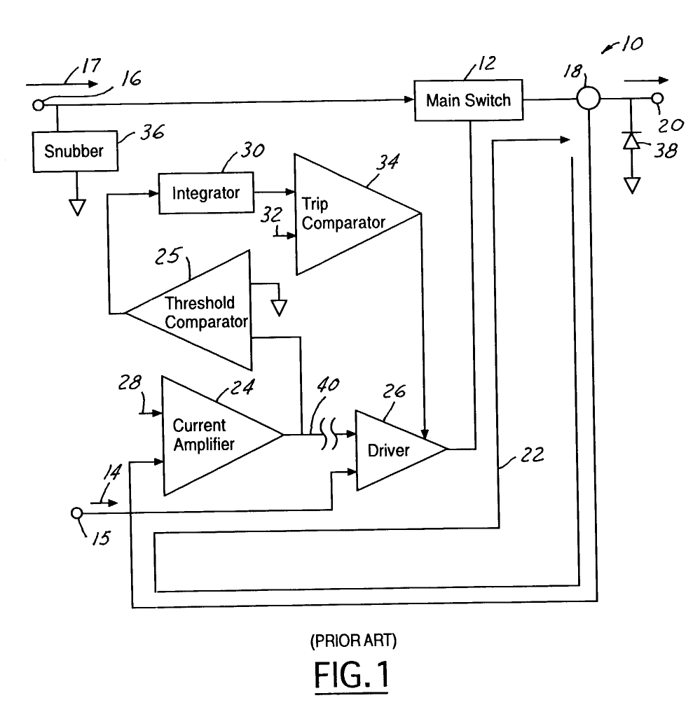

FIG. 2 is a schematic view of a multi-channel remote power controller assembly in accordance with an embodiment of the present invention;

FIG. 3 is a schematic view of a remote power controller in accordance with an embodiment of the present; and

FIG. 4 is a logic flow diagram illustrating a method of limiting current through the remote power controller in accordance with an embodiment of the present invention.

### DETAILED DESCRIPTION OF THE PREFERRED EMBODIMENT

In each of the following figures, the same reference numerals are used to refer to the same components. While the present invention is described with respect to a method and apparatus for controlling the rate of change of current through a remote power controller channel, the present invention may be adapted to be used in various applications including: spacestations, spacecraft, satellites, aircraft, ground vehicles, ground installations, watercraft, or other applications requiring the use of remote power controllers. Although, the present invention is suitable for 100-300 volt direct current power bus applications, the present invention may also be applied in applications operating in other voltage ranges.

In the following description, various operating parameters and components are described for one constructed embodiment. These specific parameters and components are included as examples and are not meant to be limiting.

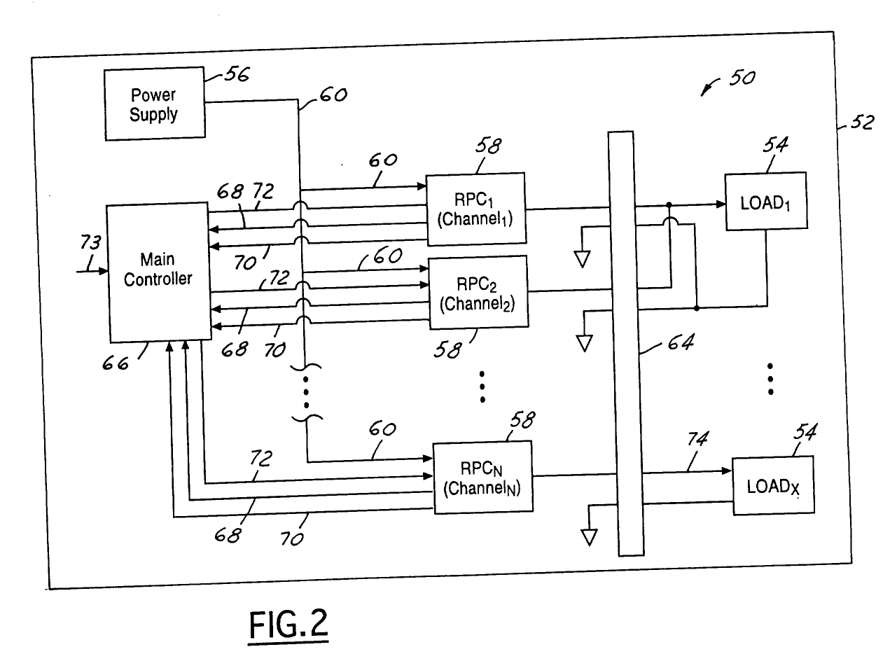

Referring now to FIG. 2, a block schematic view of a multi-channel remote power controller assembly 50 in accordance with an embodiment of the present invention, is shown. The assembly 50, as an example, is within aircraft 52 and includes loads 54 drawing current from a common power supply 56. A series of remote power controllers 58 are electrically coupled to the common power supply 56, and supply current to respective loads 54, in the form of input signals 60. Each power controller 58 corresponds to a specific channel of N channels. The loads that require more current than a single channel is capable of providing may be supplied by multiple paralleled channels, as illustrated by load₁. The loads 54 are electrically coupled to the power controllers 58 via an output power connector 64. The loads 54 may be any electrical component associated with the aircraft 52. A main controller 66 monitors telemetry signals 68 and trip latch signals 70 from the power controllers 58 and generates,command signals 72 in response to a communication signal 73. The communication signal 73 may be generated within the controller 66 or may be received externally from another electrical component within or external to the aircraft 52. The power controllers 58 in response to the command signals 72 supply power to the loads 54, in the form of output signals 74.

The controller 66 is preferably microprocessor-based such as a computer having a central processing unit, memory (RAM and/or ROM), and associated input and output buses. The controller 66 may be a portion of a central control unit or a stand-alone controller. The controller 66 in addition to monitoring the telemetry signals 68 and the trip latch signals 70 may also be in communication with other aircraft components. The communication may be onboard or offboard communication.

The controller 66 and the power controllers 58 communicate through command signals containing “ON” and “OFF” commands, command acknowledgments, and health monitoring data or status data. This is further explained in detail below.

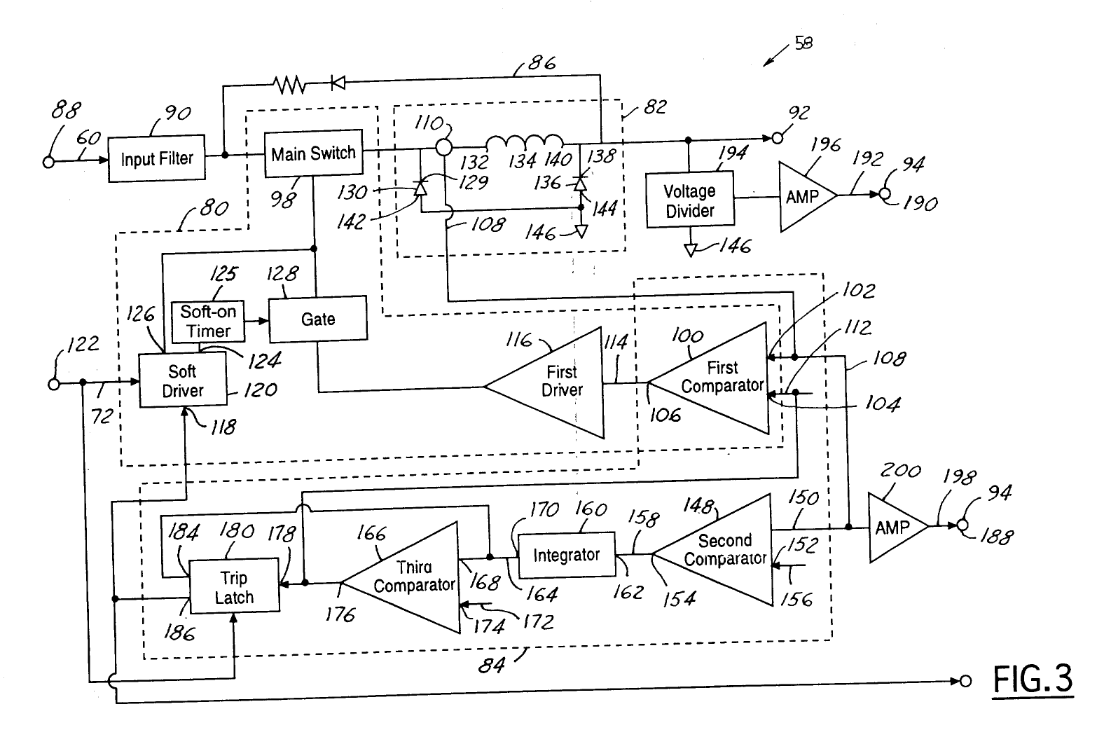

Referring now to FIG. 3, a schematic view of a remote power controller circuit 58 in accordance with an embodiment of the present, is shown. The power controller 58 includes a soft switching circuit 80 and a current limiting circuit 82. The power controller 58 may also include a tripping circuit 84 and a current limiting loop 86 as described in further detail below. The switching circuit 80 controls rate that the current limiting circuit 82 receives power. The input signal 60 is received through an input terminal 88 through an input filter 90 to the switching circuit 80. Discontinuities of current at the input terminal 88 are smoothed by the input filter 90 to prevent other channels, operating from the same power source 56, from suffering from out of specification ripple voltage. The current limiting circuit 82 upon receiving the power from the switching circuit 80 controls the rate of change of current flow to an output terminal 92. The power controller 58 may also include telemetry terminals 94 and a trip status terminal 96.

The switching circuit 80 includes a main switch 98, in general having a first state and a second state that are associated with On and OFF commands within the command signals 72 and which are determinative of whether the input signal 60 passes to the output terminal 92. The main switch 98 has a variable switching duty factor. The first state and the second state, hereinafter, are referred to as an ON state and an OFF state. The first comparator 100 has a first comparator input terminal 102, a first reference terminal 104, and a first comparator output terminal 106. The first comparator 100 compares a current signal 108, received from a current sensor 110 within the current limiting circuit 82, with a first reference signal 112 and generates a first comparator signal 114. A first driver 116 is electrically coupled to the first comparator output terminal 106 and switches the main switch 98 to the ON state in response to the first comparator signal 114. A soft driver input 118, of a soft driver 120, is electrically coupled to a command terminal 122, by which the switching circuit 80 receives the command signal 72. A first soft driver output 124 is coupled to a soft-on timer 125, which is coupled to a gate 128 and a second soft driver output 126 is electrically coupled to the main switch 98. The soft driver 120 controls switching rate that the main switch 98 is switched between the ON state and the OFF state. The soft driver 120 overrides the first driver 116 via the gate 128.

Although in a preferred embodiment of the present invention the main switch 98 is an enhancement mode n-channel power field effect transistor (FET), which uses external stimulus to generate free carriers in its conduction path to allow the main switch 98 to switch to the ON state. The main switch 98 may also be an insulated gate bipolar transistor, a junction FET, or other solid state switching device known in the art.

The first comparator 100 has a hysteresis characteristic. The hysteresis characteristic aids in controlling channel current by switching between stated of the main switch 12 for a time period determined by a rate of change of current and the amount of hysteresis. The hysteresis is not separate from the first comparator 100, but is built into the comparator 100 by using a small amount of positive feedback.

The current limiting circuit 82 includes a flyback diode 130 and a limiting inductor 134. The current limiting circuit 82 may also include the current sensor 110 electrically coupled to the main switch 98, a first cathode side 129 of the flyback diode 130, the first comparator input terminal 102, and a limiting inductor input 132 of the limiting inductor 134. The flyback diode 130 provides a current path for the limiting inductor 134 to discharge when the main switch 98 is in the OFF state. The limiting inductor 134 controls the rate of change of current flow to the output terminal 92. The limiting circuit 82 may also include a free wheeling diode 136 having a second cathode side 138 electrically coupled to a limiting inductor output 140. The free wheeling diode 136 aids in handling high frequency inductive loads. The anode sides 142 and 144 of the flyback diode 130 and the free wheeling diode 136, respectively, are electrically coupled to ground 146.

The tripping circuit 84 includes a second comparator 148 having a second comparator input terminal 150 that is electrically coupled to the current sensor 110. The second comparator 148 also has a second reference terminal 152 and a second comparator output terminal 154. The second comparator 148 compares the current signal 108 to a second reference signal 156 and generates a second comparator signal 158. An integrator 160 having an integrator input 162 that is electrically coupled to the second comparator output terminal 154, integrates the second comparator signal 158 and generates an overload time signal 164. A third comparator 166 having a third comparator input terminal 168 that is electrically coupled to the first reference terminal 104 and the integrator output 170, compares the overload time signal 164 to a third reference signal 172. The third comparator 166 also has a third reference terminal 174 and a third comparator output terminal 176. The third comparator output terminal 176 is electrically coupled to the first reference terminal 104. A trip latch input 178 of a trip latch 180 is electrically coupled to the third comparator output terminal 176 and causes the main switch 98 to switch to the OFF state in response to the third reference signal 172. The trip latch 180 provides a trip status signal 182 to the controller 66, via trip status terminal 96. A first trip latch output terminal 184 is electrically coupled to the third comparator input terminal 168. A second trip latch output terminal 186 is electrically coupled to the soft driver input 118 and the command terminal 122.

The telemetry terminals 94 include a voltage telemetry terminal 190 and a current telemetry terminal 188. A voltage telemetry signal 192 is generated by amplifying and voltage dividing the output signal via a voltage divider 194 and a first amplifier 196. A current telemetry signal 198 is generated by amplifying the current signal 108 via a second amplifier 200. The voltage telemetry signal 192 and the current telemetry signal 198 are monitored by the controller 66. The telemetry signals 68 and the trip status signals 70 may be isolated from the other circuitry using optocouplers or other isolation devices known in the art.

The controller 66 accounts for multiple channels supplying power to a single load in communicating with the power controllers 58. The controller 66 sums the current telemetry signals to provide a total current signal that represents total current that a load is drawing. The voltage telemetry signals are also monitored to determine a voltage signal associated with the particular load. The voltage signal may be determined by averaging voltages at each voltage telemetry terminal or by using some other algorithm known in the art.

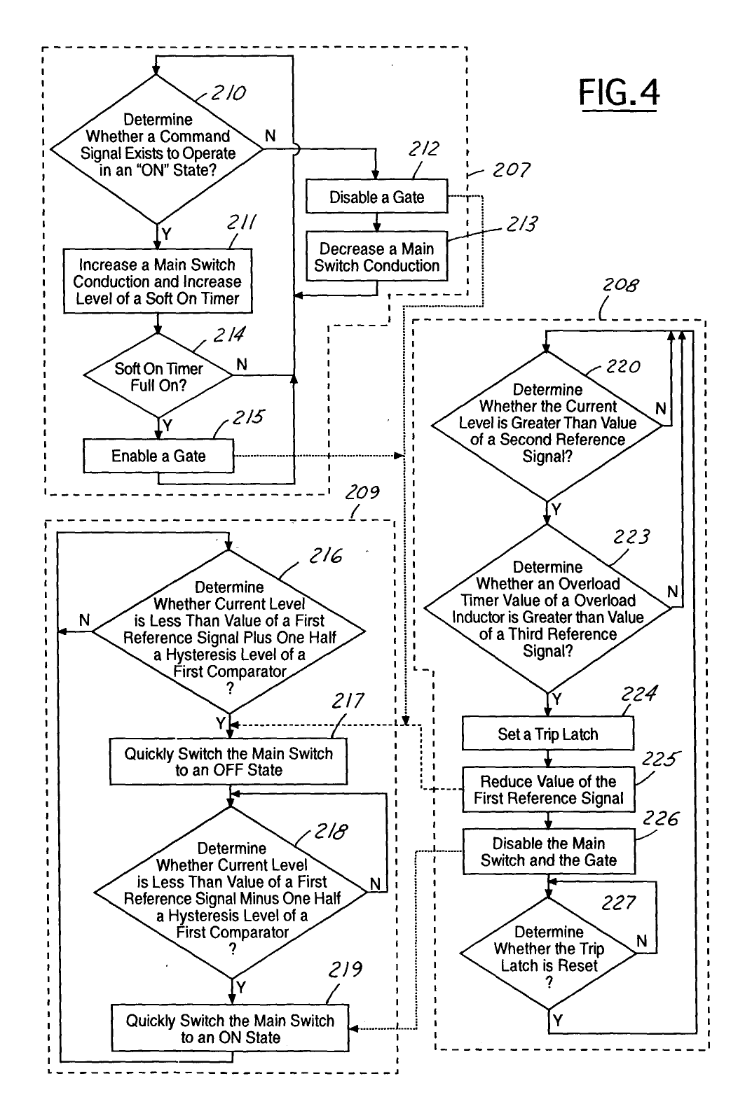

Referring now also to FIG. 4, a logic flow diagram illustrating a method of limiting current through the remote power controller 58 in accordance with an embodiment of the present invention, is shown. Operation of the remote power controller 58 may be illustrated by a combination of three state diagrams.

A first state diagram 207 illustrates state of the power controller 58 in response to command signal 72 and switching circuit 80. A second state diagram 208 illustrates state of the tripping circuit 84. The first state diagram 207 and the second state diagram 208 also illustrate control of the state of the gate 128 and the first reference signal 112. A third state diagram 209 illustrates state of the current limiting circuit 82. Interactions between the state diagrams 207, 208, and 209 are through control of the gate 128 and in response to the first reference signal 112.

Referring now to the first state diagram 207, which illustrates normal activation and deactivation of the power controller 58.

In step 210, when the switching circuit 80 receives the command signal 72 to operate in an “ON” state, the soft driver 120 slowly increases voltage level of driver output 126, increasing conduction of the switch 98. While increasing conduction of the switch 98 a time reference of the soft-on timer 125 is increased, as generally indicated by step 211. When the soft-on timer 125 reaches a pre-set timing threshold the soft-on timer 125 activates gate 128. Following step 211, step 214 is performed.

In step 214, when the soft-on timer 125 is operated in a “Full ON” state step 215 is performed, since the gate 128 is not enabled until the switch 98 reaches full conduction, otherwise step 210 is performed.

In step 215, the soft-on timer 125 activates the gate 128 at approximately the same time the switch 98 is operating at full conduction for a field effect transistor (FET).

In steps 212 and 213, when the command signal 72 is no longer in the ON state the gate 128 is disabled and the switch 98 is slowly driven out of conduction by the soft driver 120. The gate 128 allows the first driver 116 to force the switch 98 into an “OFF” state in the event of an over current condition. The gate 128 also prevents the driver 116 from forcing the switch 98 into the ON state when the switch 98 is deactivated, such as during soft ON/OFF operating conditions or when an overload trip has occurred.

Referring now to the second state diagram 208, which describes the operation of the tripping circuit 84.

In step 220, when the power controller 58 is not in an overload condition, which is monitored by the second comparator 148 via the second reference signal 156, the overload timing integrator 160 is slowly discharged. When an overload condition is detected by the second comparator 148, overload time value of the overload integrator 160 is increased.

In step 223, when overload time value of the overload integrator 160 is greater than value of a third reference signal 172 the trip latch 180 is set to a “HI” state. The third reference signal 172 corresponds to a preset limit, as detected by the third comparator 166.

In step 225, after the trip latch 180 is set, value of the first reference signal 112 is decreased to ramp down current 60 and the switch 98 is quickly switch to the OFF state, as generally indicated in step 217.

In step 226, value of the first reference signal is approximately equal to zero the gate 128 is disabled and the switch 98 is switched into the OFF state.

In step 227, the tripping circuit 84 remains in the above-described state until the trip latch 180 is reset. When the trip latch 180 is reset the power controller 58 is reactivated as in a normal operating condition and step 220 is performed.

Referring now to the third state diagram 209, which illustrates the operation of the current limiting circuit 82 and describes control of current limit level of the current 60.

In step 216, when the gate 128 is active and level of the current 60 is less than value of the first reference signal 112 plus one half of the hysteresis level of the first comparator 100, the switch 98 is driven into ohmic operation. When level of the current 60 exceeds the value of the first reference signal 112 plus one half of the hysteresis level of the first comparator 100 the switch 98 is driven into the OFF state.

In step 217, when the switch 98 is quickly switched to the OFF state by the driver 116 the inherent nature of the inductor 134 maintains current flow through terminal 92. The flyback diode 130 voltage potential at cathode 129 is slightly less than voltage potential of ground 146, resulting in a negative voltage across the inductor 134 since the voltage potential at the inductor output 140 is set by load on power controller 58. The negative voltage across the inductor 134 results in a decrease in the inductor current.

In step 218, the switch 98 remains in the OFF state until level of the current 60 decays to approximately equal one half of the hysteresis level of the first comparator 100 below level of the first reference signal 112, at which time the switch 98 is driven into the ON state when the gate 128 is active.

In step 219, when the switch 98 is switched to the ON state, the flyback diode 130 is reverse biased to deactivate the diode. With the switch 98 in the ON state, the voltage across the inductor 134 is positive, causing an increase in the inductor current. When level of the current 60 in the inductor 134 increases to one half of the hysteresis level of the comparator 100 above level of the first reference signal 112, the power controller 58 returns to step 216. When an overload condition on the output 92 has been cleared, level of the current 60 remains less than level of the first reference signal 112 and the switch 98 remains in the ON state until another overload condition exists or the power controller 58 is disabled. The switch 98 is unable to switch to the ON state when the gate 128 is disabled, as in steps 212 and 226.

The above-described steps are meant to be a general illustrative description of the operation of the power controllers 58, the steps may be performed synchronously or in a different order.

The present invention provides a single remote power controller unit design that addresses a large diverse quantity of loads without requiring physical changes to the remote power controller. The present invention also provides modular remote power controllers that reduce the volume of various different remote power controllers required for a particular application. Therefore, reducing initial design and fabrication time and costs.

The above-described apparatus, to one skilled in the art, is capable of being adapted for various purposes and is not limited to the following systems: space stations, spacecraft, satellites, aircrafts, ground vehicles, ships or other applications requiring the use of remote power controllers. The above-described invention may also be varied without deviating from the spirit and scope of the invention as contemplated by the following claims.

What is claimed is:

1. A remote power controller circuit comprising:
a main switch having a switching duty factor and operative between a first state and a second state, said main switch when in said first state allowing current to pass to an output terminal and when in said second state preventing said current from passing to said output terminal; and
a current limiting circuit electrically coupled to said main switch comprising;
a limiting inductor controlling a rate of change of current flow to said output terminal; and
a flyback diode electrically coupled to said limiting inductor and providing a current path for said limiting inductor to discharge when said main switch is in said second state.

2. A circuit as in claim 1 wherein said current limiting circuit further comprises a current sensor determining amount of current flow between said main switch and said output terminal and generating a current signal.

3. A circuit as in claim 2 wherein said remote power controller further comprises:
a soft switching circuit comprising;
said main switch;
a first comparator comparing said current signal with a first reference signal and generating a first comparator signal; and
a first driver switching said main switch to said first state in response to said first comparator signal.

4. A circuit as in claim 3 wherein said soft switching circuit further comprises:
a soft driver switching said main switch at a determined rate in response to a command signal; and
a soft drive timer activating a gate when said main switch approximately reaches full conduction;
said soft driver and soft drive timer overriding said first driver via said gate.

5. A circuit as in claim 4 wherein said determined rate is predetermined and programmed into said soft driver or is contained within said command signal.

6. A circuit as in claim 3 wherein said first comparator has a hysteresis characteristic.

7. A circuit as in claim 2 further comprising a tripping circuit comprising:
a second comparator electrically coupled to said current sensor and comparing said current signal to a second reference signal and generating a second comparator signal;
an integrator electrically coupled to said second comparator and integrating said second comparator signal and generating an overload time signal;
a third comparator electrically coupled to said integrator and comparing said overload time signal to a third reference signal; and
a trip latch electrically coupled to said third comparator and causing said main switch to switch to said second state in response to said third reference signal.

8. A circuit as in claim 7 wherein said soft switching circuit switches said main switch to said second state in response to a trip latch state.

9. A circuit as in claim 1 further comprising a current limiting loop preventing current on said output terminal from increasing above a predetermined threshold value.

10. A circuit as in claim 1 further comprising an input filter limiting channel-to-channel ripple effect.

11. A circuit as in claim 1 further comprising voltage or current telemetry output signals.

12. A circuit as in claim 1 further comprising a trip status output signal.

13. A multi-channel remote power controller assembly comprising:
a plurality of loads drawing current from a common power supply;
a main controller generating a one or more command signals in response to a communication signal;
a plurality of remote power controllers electrically coupled to said plurality of loads, said common power supply, and said main controller, said plurality of remote power controllers comprising;
a main switch having a switching duty factor and operative between a first state and a second state in response to said one or more command signals, said main switch when in said first state allowing current to pass to an output terminal and when in said second state preventing said current from passing to said output terminal; and
a current limiting circuit electrically coupled to said main switch comprising;
a limiting inductor controlling a rate of change of current flow to said output terminal; and
a flyback diode electrically coupled to said limiting inductor and providing a current path for said limiting inductor to discharge when said main switch is in said second state.

14. An assembly as in claim 13 wherein said controller causes said plurality of power controllers to operate in said second state in response to a trip latch state.

15. An assembly as in claim 13 wherein said controller controls operating states of said plurality of power controllers in response to plurality of telemetry signals.

16. An assembly as in claim 13 wherein said current limiting circuit further comprises a current sensor determining amount of current flow between said main switch and said output terminal and generating a current signal.

17. An assembly as in claim 16 wherein said plurality of power controllers further comprise:
a soft switching circuit comprising;
said main switch;
a first comparator comparing said current signal with a first reference signal and generating a first comparator signal; and
a first driver switching said main switch to said first state in response to said first comparator signal.

18. A circuit as in claim 17 wherein said soft switching circuit further comprises:
a soft driver switching said main switch at a determined rate in response to a command signal;
said soft driver overriding said first driver via a gate.

19. An assembly as in claim 16 wherein said plurality of remote power controllers further comprise a tripping circuit comprising:
a second comparator electrically coupled to said current sensor and comparing said current signal to a second reference signal and generating a second comparator signal;
an integrator electrically coupled to said second comparator and integrating said second comparator signal and generating an overload time signal;
a third comparator electrically coupled to said integrator and comparing said overload time signal to a third reference signal; and
a trip latch electrically coupled to said third comparator and causing said main switch to switch to said second state in response to said third reference signal.

20. A method of limiting current through a remote power controller that comprises a limiting inductor comprising:
controlling a switching duty factor;
controlling voltage that is received by said limiting inductor;
controlling a rate of change of current flow to an output terminal of the remote power controller; and
discharging a limiting inductor when output current flow is above a determined current threshold.
